(19) United States
(12) Patent Application Publication
(10) Pub. No.: US 2009/0128584 A1
(43) Pub. Date: May 21, 2009

(54) Apparatuses and methods for converting sub-pixel data using pipe-lined dithering modules

(76) Inventors: Jae Chul Lee, Seoul (KR); Keun-Ho Ryu, Yongin-si (KR); Jong Seon Kim, Seongnam-si (KR)

Correspondence Address: HARNESS, DICKEY & PIERCE, P.L.C., P.O. BOX 8910, RESTON, VA, 20195, US

(21) Appl. No.: 12/232,960

(22) Filed: Sep. 26, 2008

(30) Foreign Application Priority Data
Sep. 27, 2007 (KR) 10-2007--0097319

(51) Int. Cl. G09G 5/10; G09G 3/36

(52) U.S. Cl. 345/690; 345/87

(57) ABSTRACT

A sub-pixel data conversion apparatus may include: a gamma correction block that converts input sub-pixel data to first sub-pixel data; and a dithering process block that generates a first dithering mask pattern and that performs a first dithering operation on the first sub-pixel data to a second sub-pixel data based on the generated first dithering mask pattern. A sub-pixel data gamma correction method may include setting error data for gamma correction on sub-pixel data and extracting error data corresponding to input sub-pixel data, adding the extracted error data and the input sub-pixel data, and converting the input sub-pixel data to first sub-pixel data based on a result of the addition. A sub-pixel data dithering method may include: generating a first dithering mask pattern and performing a first dithering operation; and generating a second dithering mask pattern and performing a second dithering operation.

### PRIORITY STATEMENT

This application claims priority from Korean Patent Application No. 10-2007-0097319, filed on Sep. 27, 2007, in the Korean Intellectual Property Office (KIPO), the entire contents of which are incorporated herein by reference.

### BACKGROUND

1. Field

Example embodiments relate to apparatuses and methods for converting sub-pixel data. Also, example embodiments relate to sub-pixel data converting apparatuses and methods for performing gamma correction of sub-pixel data using error data and for performing dithering processes on the gamma-corrected sub-pixel data using a pipe-lined dithering mask pattern which is random in time and/or in space.

2. Description of Related Art

The display device, e.g., a liquid crystal display device, may be an apparatus displaying input sub-pixel data on a display panel.

Sub-pixel data (e.g., R data, G data, and/or B data) for driving the liquid crystal display device may be input to a liquid crystal display device from, for example, a graphic card of a personal computer. Through gamma correction of input sub-pixel data, a bit number of the input sub-pixel data may increase.

The liquid crystal display device may have a limitation in the number of grayscales that may be displayed. For example, when input sub-pixel data is 8 bits, but a liquid crystal display device may process only 6 bits of sub-pixel data, the liquid crystal display device may not display a number of grayscales equal to 2⁸-2⁶.

Therefore, a liquid crystal display device displaying a lower number of grayscales than input sub-pixel data may apply a dithering technique for displaying an image as close as possible to an original image.

Each pixel composing a pixel image of a liquid crystal display device may include a red sub-pixel, a green sub-pixel, and/or a blue sub-pixel, and/or sub-pixel data (e.g., R sub-pixel data) corresponding to each of these sub-pixels (e.g., an R-sub-pixel).

If sub-pixel data applied to each of these sub-pixels has a reduction in the number of grayscale, a false contour line representing a definite contour line shown at the boundaries of a screen and/or Mach's phenomenon representing a bright band or dark band shown on a screen may occur. In order to avoid this false contour line and/or Mach's phenomenon, input sub-pixel data may be converted to sub-pixel data having the number of bits that may be processed in a data driving unit of a liquid crystal display device. This type of data conversion may be known as “dithering”.

### SUMMARY

Example embodiments may provide sub-pixel data converting apparatuses that may reduce memory volume storing parameters for gamma correction (and methods thereof. The sub-pixel data converting apparatuses may be capable of dithering processes to prevent a fixed pattern from occurring on a display panel in time or space (and methods thereof).

According to example embodiments, a sub-pixel data conversion apparatus may include: a gamma correction block, based on error data which may be set in advance and may have a number of bits less than or equal to a number of bits of input sub-pixel data, that may convert the input sub-pixel data to first sub-pixel data; and/or a dithering process block that may generate a first dithering mask pattern which may be random in time and/or space for a first macro pixel that may have a sub-pixel as a first reference unit, and/or that may perform a first dithering operation on the first sub-pixel data to a second sub-pixel data based on the generated first dithering mask pattern.

According to example embodiments, a sub-pixel data gamma correction method may include: setting error data for gamma correction on sub-pixel data, the error data may have a number of bits less than or equal to a number of bits of the sub-pixel data; and/or extracting error data corresponding to input sub-pixel data, adding the extracted error data and the input sub-pixel data, and/or converting the input sub-pixel data to first sub-pixel data based on a result of the addition. A number of bits of the first sub-pixel data may be greater than a number of bits of the input sub-pixel data.

According to example embodiments, a sub-pixel data dithering method may include: generating a first dithering mask pattern, which may be random in time and/or space for a first macro pixel that may have a sub-pixel as a first reference unit; performing a first dithering operation on a first sub-pixel data to a second sub-pixel data based on the generated first dithering mask pattern; generating a second dithering mask pattern, which may be random in time and/or space for a second macro pixel having the first macro pixel as a second reference unit; and/or performing a second dithering operation on the second sub-pixel data to a third sub-pixel data based on the generated second dithering mask pattern.

### BRIEF DESCRIPTION OF THE DRAWINGS

The above and/or other aspects and advantages will become more apparent and more readily appreciated from the following detailed description of example embodiments, taken in conjunction with the accompanying drawings in which:

FIG. 1 is a block diagram of a sub-pixel data converting apparatus according to example embodiments;

FIG. 2 shows gamma-corrected sub-pixel data, gamma-corrected by a gamma correction block, as illustrated in FIG. 1;

FIG. 3 is a block diagram of a first dithering mask pattern generation unit illustrated in FIG. 1;

FIG. 4 is a schematic diagram explaining operation of the first dithering mask pattern generation unit illustrated in FIG. 3;

FIG. 5 is a block diagram of the first dithering operation unit illustrated in FIG. 1;

FIG. 6 is a block diagram of a second dithering mask pattern generation unit illustrated in FIG. 1;

FIG. 7 is a schematic diagram explaining operation of the second dithering mask pattern generation unit illustrated in FIG. 6;

FIG. 8 is a block diagram of the second dithering operation unit illustrated in FIG. 1;

FIG. 9 is a block diagram of a display device according to example embodiments; and

FIG. 10 is a flowchart of a sub-pixel data converting method according to example embodiments.

### DETAILED DESCRIPTION OF EXAMPLE EMBODIMENTS

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

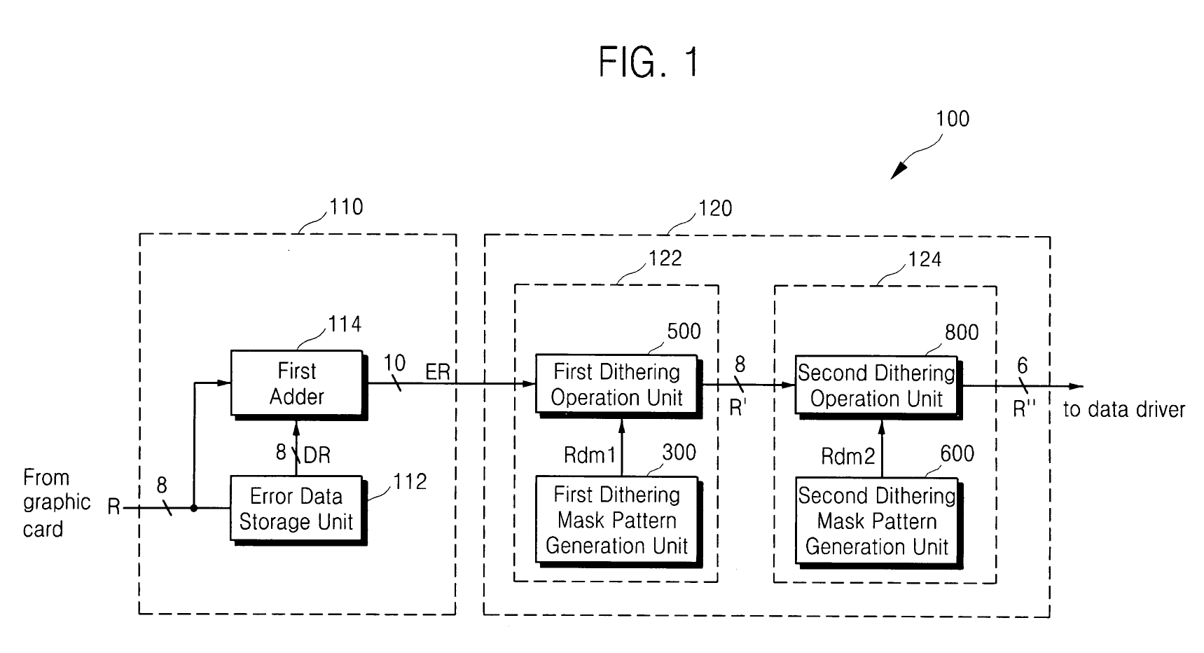

FIG. 1 is a block diagram of sub-pixel data conversion apparatus 100 according to example embodiments. Referring to FIG. 1, sub-pixel data conversion apparatus 100 may include gamma correction block 110 performing a gamma correction on first (input) sub-pixel data R and/or dithering process block 120 performing a dithering process on gamma-corrected sub-pixel data ER.

First sub-pixel data R may be red sub-pixel data, green sub-pixel data, and/or blue sub-pixel data, that may be input from a graphics card or similar device.

Gamma correction block 110 may convert first sub-pixel data R to gamma-corrected sub-pixel data ER based on error data DR, which may or may not be set in advance and/or may have a number of bits less than or equal to that of first sub-pixel data R.

Gamma correction block 110 may include error data storage unit 112 and/or first adder 114. Error data storage unit 112 may store error data DR (that may or may not be preset representing a difference between a value of first sub-pixel data R and a value of gamma-corrected sub-pixel data ER. Error data storage unit 112 may extract error data DR corresponding to first sub-pixel data R.

First adder 114 may add first sub-pixel data R and error data DR extracted from error data storage unit 112 and/or may output gamma-corrected sub-pixel data ER.

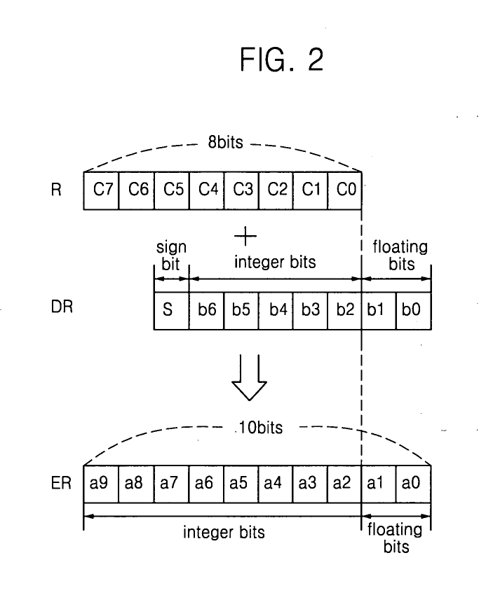

FIG. 2 shows gamma-corrected sub-pixel data ER, gamma corrected by gamma correction block 110, as illustrated in FIG. 1. Referring to FIG. 2, when first sub-pixel data R is 8 bits, error data DR also may be 8 bits. Error data DR (e.g., 8 bits) may include sign bit S (e.g., 1 bit), integer bits (e.g., five bits [b6:b2]), and/or floating bits (e.g., two bits [b1:b0]). Sign bit S may indicate a sign of error data DR. Integer bits (e.g., [b6:b2]) may indicate an integer part of the difference between a value of first sub-pixel data R (e.g., [C7:C0]) and a value of gamma-corrected sub-pixel data ER (e.g., [a9:a0]). Floating bits [b1:b0] may indicate a decimal part of error data DR and/or may indicate a decimal part of the difference between the value of first sub-pixel data R (e.g., [C7:C0]) and the value of gamma-corrected sub-pixel data ER (e.g., [a9:a0]). Decimal part [b1:b0] of error data DR may be decimal part [a1:a0] of gamma-corrected sub-pixel data ER (e.g., [a1:a0]=[b1:b0]).

In addition, integer portion [a9:a2] of gamma-corrected sub-pixel data ER (e.g., ten bits [a9:a0]) may be a result of adding an integer portion (e.g., [b6:b2]) of error data DR and first sub-pixel data R [C7:C0], based on sign bit S. In this way, gamma correction block 110 may convert first sub-pixel data R (e.g., eight bits [C7:C0]) to gamma-corrected sub-pixel data ER (e.g., ten bits [a9:a0]).

Gamma correction block 110 may perform gamma correction independently on red sub-pixel data, green sub-pixel data, and/or blue sub-pixel data that may be, for example, 8 bits input from a graphics card or similar device. This gamma-corrected sub-pixel data ER (e.g., of 8 bits) may be extended to gamma-corrected sub-pixel data ER (e.g, of 10 bits).

When a mapping method of 1:1 is used to convert K-bit first sub-pixel data R (where K is a natural number, for example, K=8) to N-bit gamma-corrected sub-pixel data ER (where N is natural number greater than K, for example, N=10), a memory volume of 2^{K}*N (for example, 2⁸*10) may be required to store parameters for the 1:1 mapping.

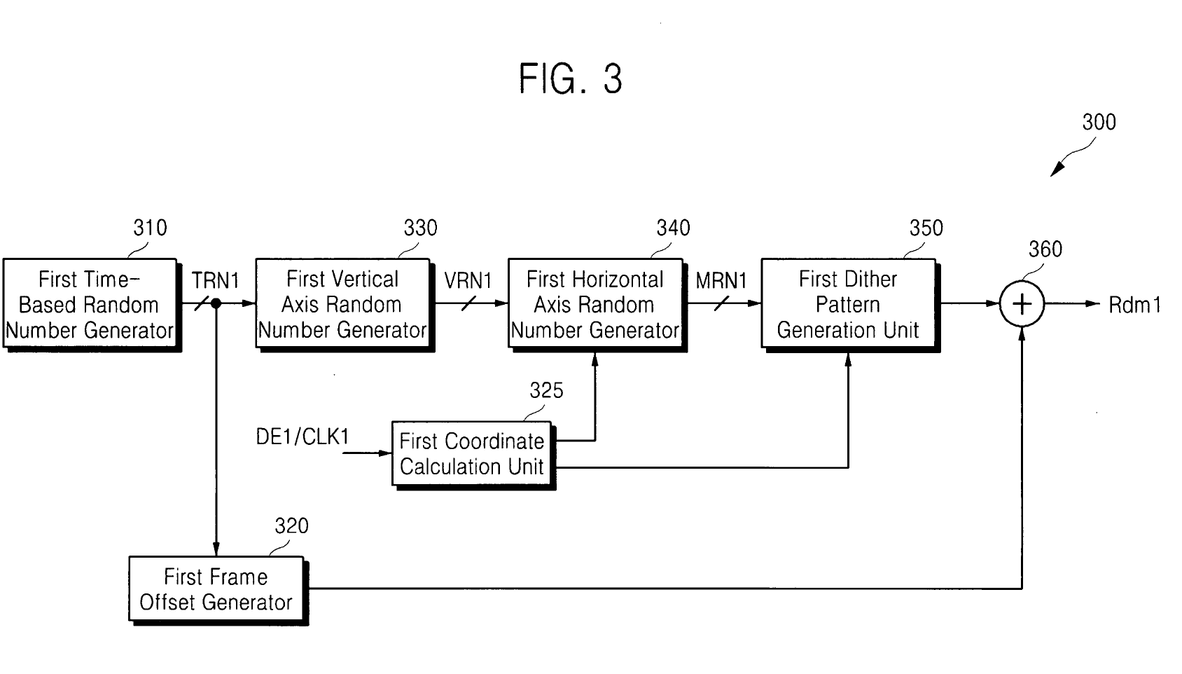

On the other hand, gamma correction block 110 according to example embodiments, illustrated in FIGS. 2 and 3, may use M-bit error data (where M is natural number less than N) for gamma correction, so that a memory volume required for gamma correction may be only 2^{K}*M (for example, 2⁸*8).

Thus, a memory volume required for gamma correction by gamma correction block 110 according to example embodiments may be reduced in comparison with a memory volume required for gamma correction by a 1:1 mapping method. Additionally, gamma correction block 110 may extend sub-pixel data by storing error data only, so that gamma correction may not require an additional data packing logic and/or an additional data unpacking logic when storing a parameter for gamma correction.

According to FIG. 1, dithering process block 120 may include first dithering module 122 and/or second dithering module 124. First dithering module 122 may generate a first dithering mask pattern Rdm1 (that may be random in time and/or in space) for a first macro pixel that may have a sub-pixel as a reference unit and/or may perform a dithering operation on gamma-corrected sub-pixel data ER to generate second sub-pixel data R′ based on the generated first dithering mask pattern Rdm1.

First dithering module 122 may include first dithering mask pattern generation unit 300 and/or first dithering operation unit 500.

First dithering mask pattern generation unit 300 may randomly set a first macro random number for the first macro pixel included in a frame, that may be randomly selected in time among a plurality of first frames, and/or may set the first dithering mask pattern based on the set first macro random number. The plurality of first frames may be, for example, 4 frames.

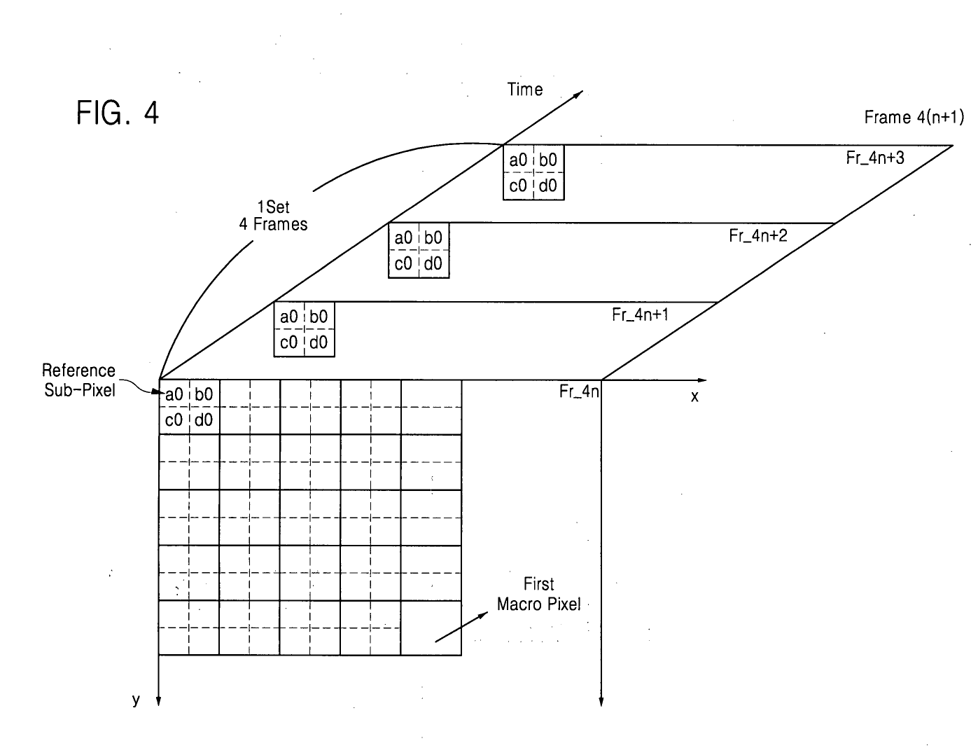

FIG. 3 is a block diagram of first dithering mask pattern generation unit 300 illustrated in FIG. 1. FIG. 4 is a schematic diagram explaining operation of first dithering mask pattern generation unit 300 illustrated in FIG. 3.

Referring to FIGS. 3 and 4, first dithering mask pattern generation unit 300 may include first time-based (or time axis) random number generator 310, first frame offset generator 320, first coordinate calculation unit 325, first vertical axis random number generator 330, first horizontal axis random number generator 340, first dither pattern generation unit 350, and second adder 360.

First time-based random number generator 310 may generate first time axis random number TRN1 for first frames Fr_4n to Fr_4n+3 (where n is a natural number). First time axis random number TRN1 may be, for example, one of {0, 1, 2, 3}.

First frame offset generator 320 may select and/or may output one of a plurality of frame offset values based on generated first time axis random number TRN1. For example, when performing dithering for converting gamma-corrected sub-pixel data ER (e.g., 10 bits) to second sub-pixel data R′ (e.g., 8 bits), first frame offset generator 320 may select and/or may output one of the plurality of offset values (e.g., {0, 1, 2, 3}) based on first time axis random number TRN1.

First coordinate calculation unit 325 may calculate coordinates (x, y), where sub-pixel data (e.g., first sub-pixel data R) may be to be displayed in response to first enable signal DE1 and/or first clock signal CLK1. First vertical axis random number generator 330 may generate first vertical axis random number VRN1 based on a coordinate value (x, y) calculated by first coordinate calculation unit 325 whenever a display panel line is changed (e.g., when the y coordinate may be changed).

First horizontal axis random number generator 340 may generate a first macro random number MRN1 for a first macro pixel (e.g., 2*2 macro pixel {an, bn, cn, dn}) having a sub-pixel as a reference unit based on first vertical axis random number VRN1.

For example, in a dithering process that converts gamma-corrected sub-pixel data ER (e.g., 10 bits) to second sub-pixel data R′ (e.g., 8 bits), the first macro pixel may be determined by a 2×2 sub-pixel size and/or may set first macro random number MRN1 (e.g., {0, 1, 2, 3}) randomly for the first macro pixel.

First dither pattern generation unit 350 may generate a first dithering mask pattern Rdm1 (that may be random in time and/or in space) based on first macro random number MRN1 assigned to the first macro pixel. First dithering mask pattern generation unit 300 may generate first dithering mask pattern Rdm1 that may have, for example, an average in time equal to an average in space.

According to FIG. 4, the first macro pixel may consist of a (2×2) sub-pixel unit. First dither pattern generation unit 350 may randomly set first macro random number MRN1 (e.g., MRN1={0, 2, 3, 1}) to the first macro pixel (e.g., {a0, b0, c0, d0}) using a function f: X→Y.

First dither pattern generation unit 350 may generate a first dither pattern value randomly based on first macro random number MRN1 (e.g., MRN1={0, 2, 3, 1}). For example, a value set for each sub-pixel included in the first macro pixel by the function f: X→Y may be called first dither pattern value.

A function f may be a 1:1 function between a domain X={an, bn, cn, dn} and a range Y={0, 1, 2, 3}. Thus, sub-pixels included in the first macro pixel may not have the same first dithering mask pattern value as each other.

A dithering mask pattern for a first macro pixel {a0, b0, c0, d0} of a first frame FR_4n (where n is a natural number) may be determined randomly to {1, 0, 2, 3}.

A dithering mask pattern value of each sub-pixel included in a first macro pixel {a1, b1, c1, d1} of a second frame FR_4n+1 may be set to one of the first dithering mask pattern values, except for a first dithering mask pattern value selected at a sub-pixel of the same coordinates of a first frame FR_4n.

In other words, a first dithering mask pattern value of a sub-pixel a1 may be randomly selected to one of {0, 2, 3}, but not {1}, because a0 is selected to {1}. In this way, a first dithering mask pattern value of each sub-pixel {b1, c1, d1} may be set up randomly.

For example, a dithering mask pattern of a first macro pixel {a1, b1, c1, d1} of a second frame may be determined to {0, 3, 1, 2}.

In a similar manner, a first dithering mask pattern value of a sub-pixel included in a first macro pixel {a2, b2, c2, d2} of a third frame FR_4n+2 may be set to one of the first dithering mask pattern values remaining, except a first dithering mask pattern value determined at an equal-coordinates sub-pixel of a first frame FR_4n and a second frame FR_4n+1.

That is, a first dithering mask pattern value of a sub-pixel a2 may be selected to one of {2, 3}, but not one of {0, 1}, because a0 is selected to {1} and a1 is selected to {0}. In this way, a first dithering mask pattern value of each sub-pixel {b1, c1, d1} may be set randomly.

For example, a dithering mask pattern of a first macro pixel {a2, b2, c2, d2} of a third frame FR_4n+2 may set to {2, 1, 3, 0}. A dithering mask pattern of a first macro pixel {a3, b3, c3, d3} of a fourth frame FR_4n+3 may be automatically set to {3, 2, 0, 1}, since it should satisfy a condition that an average in time should be equal to an average in space.

First dither pattern generation unit 350 may be embodied by way of reading dither pattern information that may correspond to first macro random number MRN1 (or first dithering mask pattern values set for each sub-pixel) from a dither table storing dither patterns that may satisfy the condition that an average in time should be equal to an average in space.

Second adder 360 may perform a logic operation (e.g., addition) on first dither pattern values of each coordinate generated by first dither pattern generation unit 350 and/or a frame offset value generated by first frame offset generator 320.

Second adder 360 may generate first dithering mask pattern Rdm1 according to a result of the logic operation. For example, when a first dither pattern value of a first macro pixel {a0, b0, c0, d0} of a first frame FR_4n for sub-pixel data R is {1, 0, 2, 3} and the frame offset value is 2, first dithering mask pattern Rdm1 may be {3, 2, 0, 1}. By such operation, first dithering mask pattern Rdm1, random in time and/or in space may be generated. Carry digits resulting from addition may be, for example, abandoned (or discarded).

First time-based random number generator 310, first vertical axis random number generator 330, and/or first horizontal axis random number generator 340 may respectively be embodied using a shift register and/or a logic gate. For example, first vertical axis random number generator 330 may generate first vertical axis random number VRN1 by loading first time axis random number TRN1 generated by first time-based random number generator 310 to a shift register (not shown) as seed data.

Additionally, first horizontal axis random number generator 340 may generate first macro random number MRN1 by loading first vertical axis random number VRN1 as seed data to a shift register (not shown). Applying, for example, an Endian-Swapping method may minimize a relationship when loading to the shift register. First dithering operation unit 500 may convert gamma-corrected sub-pixel data ER to second sub-pixel data R′ based on first dithering mask pattern Rdm1.

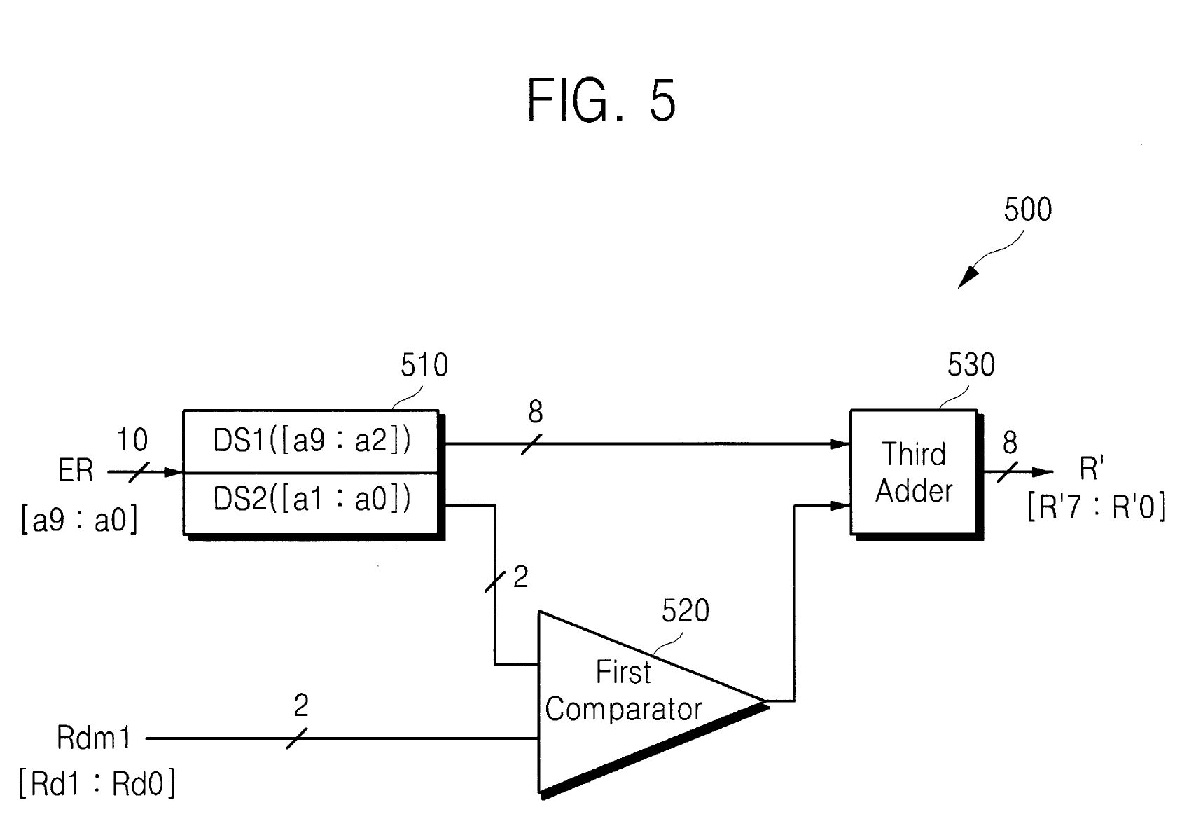

FIG. 5 is a block diagram of first dithering operation unit 500 illustrated in FIG. 1. Referring to FIGS. 1 and 5, first dithering operation unit 500 may include first data separator 510, first comparator 520, and/or third adder 530.

First data separator 510 may separate gamma-corrected sub-pixel data ER into first data set DS1 and second data set DS2. For example, when performing a dithering operation to convert gamma-corrected sub-pixel data ER (e.g., 10 bits [a9:a0]) to second sub-pixel data R′ (e.g., 8 bits [C′7:C′0]), first data set DS1 may be [a9:a2] and/or second data set DS2 may be [a1:a0].

First comparator 520 may compare a value of second data set DS2 (e.g., two bits [a1:a0]) with a value of first dithering mask pattern Rdm1 (e.g., two bits [Rd1:Rd0]).

First comparator 520 may output “1” when the value of second data set DS2 (e.g., two bits [a1:a0]) is greater than the value of first dithering mask pattern Rdm1 (e.g., two bits [Rd1:Rd0]), and/or otherwise, it may output “0”.

Third adder 530 may add a value of first data set DS1 (e.g., eight bits [a9:a0]) and an output value of first comparator 520 and/or may output second sub-pixel data R′ (e.g., eight bits [R′7:R′0]) based on a result of the addition. Thus, a 2×2 first macro pixel may be randomly dithering-processed in time and/or in space.

Second dithering module 124 may generate a second dithering mask pattern Rdm2 (that may be random in time and/or in space) for a second macro pixel that may have the first macro pixel as a reference unit. Second dithering module 124 may convert second sub-pixel data R′ to third sub-pixel data R″ based on generated second dithering mask pattern Rdm2.

Second dithering module 124 may include second dithering mask pattern generation unit 600 and/or second dithering operation unit 800.

Second dithering pattern mask generation unit 600 may randomly set a second macro random number for the second macro pixel included in a sub frame, that may be randomly selected by time among a plurality of sub-frames including the plurality of the first frames.

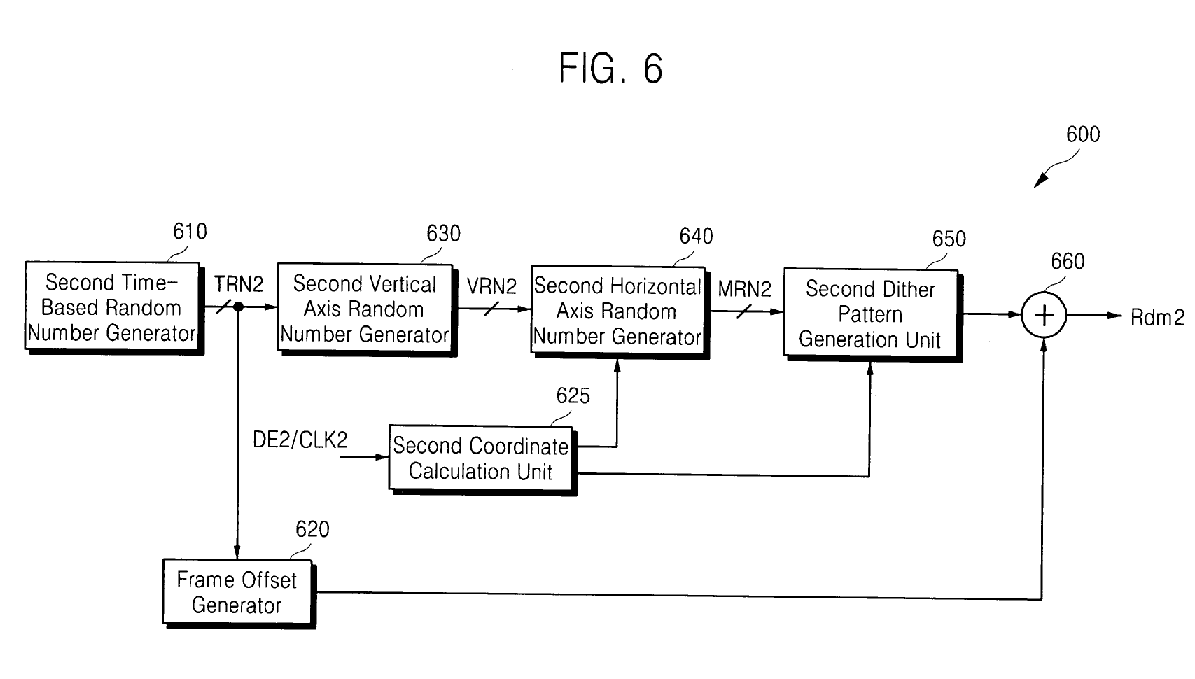

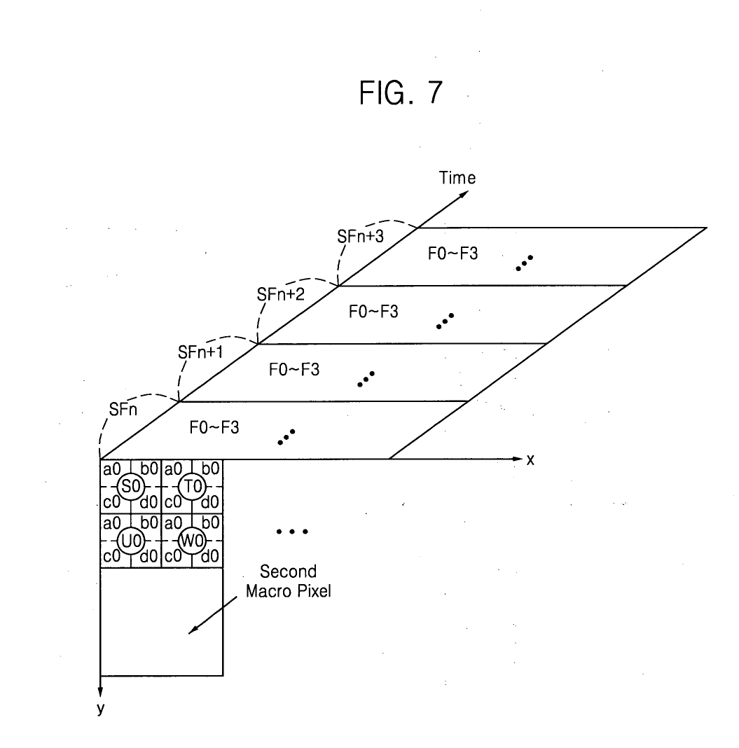

FIG. 6 is a block diagram of second dithering mask pattern generation unit 600 illustrated in FIG. 1. FIG. 7 is a schematic diagram explaining operation of second dithering mask pattern generation unit 600 illustrated in FIG. 6.

Referring to FIGS. 6 and 7, second dithering mask pattern generation unit 600 may include second time-based (or time axis) random number generator 610, second frame offset generator 620, second coordinate calculation unit 625, second vertical axis random number generator 630, second horizontal axis random number generator 640, second dither pattern generation unit 650, and/or fourth adder 660.

Second time-based random number generator 610 may generate second time axis random number TRN2 for each of sub frames SFn to SFn+3 (where n is a natural number). Each of sub frames SFn to SFn+3 may include, for example, four frames F0 to F3.

Second time axis random number TRN2 corresponding to each of the four sub frames SFn to SFn+3 may be set up randomly and, for example, may be {0, 1, 3, 2}.

Second frame offset generator 620 may select and/or may output one of a plurality of frame offset values based on generated second time axis random number TRN2. Second coordinate calculation unit 625 may calculate coordinates (x, y), where sub-pixel data may be displayed in response to second enable signal DE2 and/or second clock signal CLK2. Second vertical axis random number generator 630 may generate second vertical axis random number VRN2 at every Y line (e.g., Y=2) of the display panel based on the display coordinate value (x, y).

Second horizontal axis random number generator 640 may generate second macro random number MRN2 for a second macro pixel {S0, T0, U0, W0} based on second vertical axis random number VRN2. Second macro pixel {S0, T0, U0, W0} may be a 2×2 macro pixel having first macro pixel unit {an, bn, cn, dn} as a reference macro pixel unit. Second dither pattern generation unit 650 may generate a second dither pattern (random in terms of time and/or space) based on second macro random number MRN2.

According to FIG. 7, second dither pattern generation unit 650 may generate a random second dither pattern by setting up the second macro random number MRN2 (e.g., {0, 2, 3, 1}) to the second macro pixel using a function g: P→Q. For example, second dither pattern value may be named for a value set to a pixel that may have first macro pixel ({an, bn, cn, and dn}, e.g., n=0) included in the second macro pixel ({Sn, Tn, Un, and Wn, e.g., n=0}, where n is an integer greater than or equal to 0) as a reference unit, by the function g: P→Q.

Here, the function g may be a 1:1 function between a domain P={Sn, Tn, Un, Wn} and a range Q={0, 1, 2, 3}. Second dither pattern generation unit 650 may be embodied by a method of reading dither pattern information corresponding to second macro random number MRN2 from a dither table storing dither patterns that may satisfy a condition that an average in time should be equal to an average in space.

Fourth adder 660 may generate second dithering mask pattern Rdm2 by adding a second dither pattern value generated by second dither pattern generation unit 650 and a frame offset value generated by second frame offset generator 620.

Accordingly, second dithering mask patter generation unit 600 may generate second dithering mask pattern Rdm2 (that may be random in time and/or in space) for total 16 frames ({SF0˜SF3, SF4˜SF7, SF8˜SF11, and SF12˜SF15}) composed of four sub frames SFn to SFn+3.

Second time-based random number generator 610, second vertical axis random number generator 630, and/or second horizontal axis random number generator 640 may be embodied using a shift register and/or a logic gate. Second dithering operation unit 800 may convert second sub-pixel data R′ to third sub-pixel data R″ based on second dithering mask pattern Rdm2.

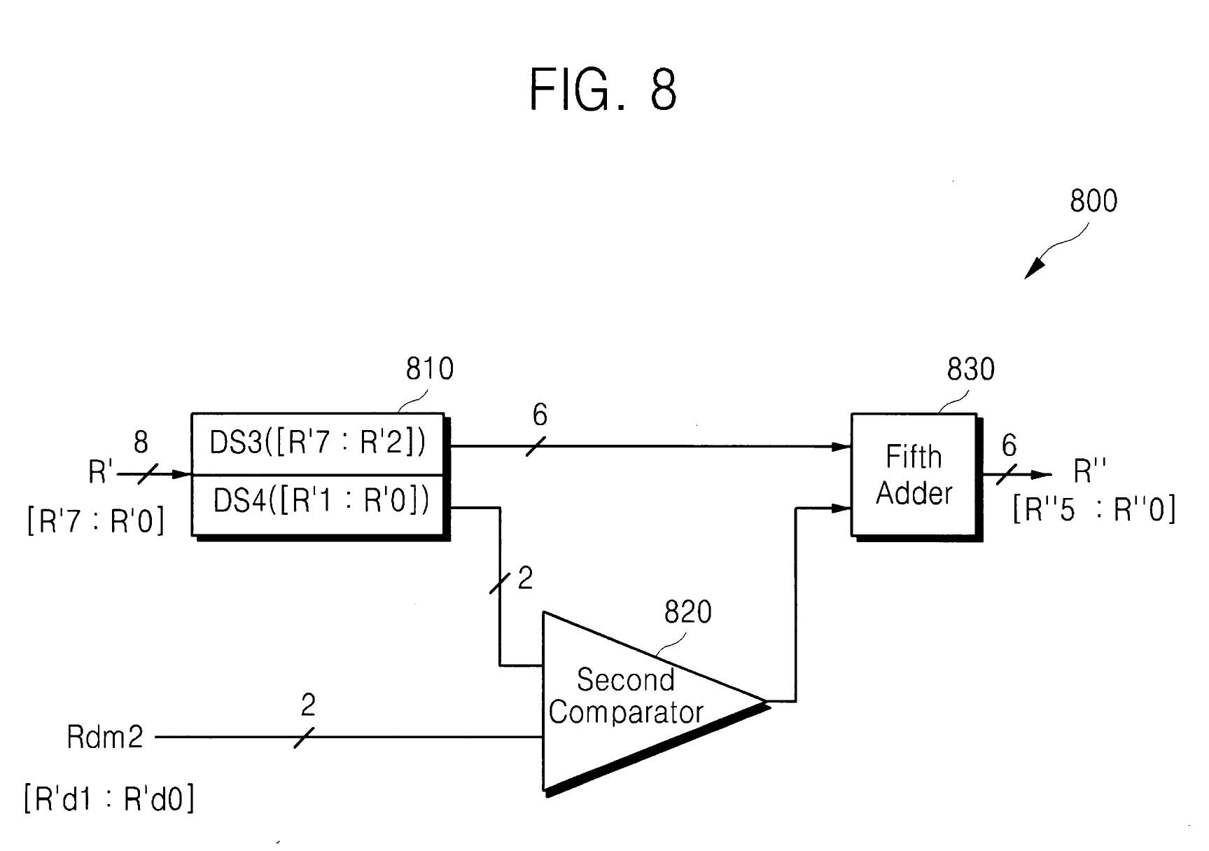

FIG. 8 is a block diagram of second dithering operation unit 800 illustrated in FIG. 1. Referring to FIGS. 1 and 8, second dithering operation unit 800 may include second data separator 810, second comparator 820, and/or fifth adder 830.

Second data separator 810 may separate second sub-pixel data R′ (e.g., [R′7:R′0]) into third data set DS3 and fourth data set DS4. Third data set DS3 may be [R′7:R′2] and/or fourth data set DS4 may be [R′1:R′0].

Second comparator 820 may compare a value of fourth data set DS4 (e.g., [R′1:R′0]) with second dithering mask pattern Rdm2 (e.g., [Rd′1:Rd′0]). Second comparator 820 may output “1” when fourth data set DS4 (e.g., [R′1:R′0]) is greater than second dithering mask pattern Rdm2 (e.g., [Rd′1:Rd′0]), and/or otherwise, it may output “0”.

Fifth adder 830 may add a value of third data set DS3 (e.g., six bits [R′7:R′2]) and an output value of second comparator 820, and/or may output third sub-pixel data R″ (e.g., six bits [R″5:R″0]).

First dithering module 122 may perform a dithering process by setting randomly first macro pixels ({an, bn, cn, dn}) composed of 2×2 pixels. Second dithering module 124 may perform a dithering process by setting randomly second macro pixel ({Sn, Tn, Un, Wn}) having the first macro pixel ({an, bn, cn, dn}) as a reference unit.

The pipe-lined dithering module may comprise first dithering module 122 and/or second dithering module 124. For example, a pipe-lined 4-bit dithering module may perform a dithering operation converting gamma-corrected sub-pixel data ER (e.g., 10 bits) to pixel data R″ (e.g., 6 bits).

According to a result of the dithering process by the pipe-lined 4-bit dithering module, a dithering mask pattern may be generated (that may be random in time and/or in space) for total 16 frames and/or total 16 sub-pixels.

Therefore, performing a dithering process on gamma-corrected sub-pixel data ER according to a random dithering mask pattern generated by a sub-pixel data conversion apparatus 100 illustrated in FIG. 1 (e.g., first dithering mask pattern Rdm1 and/or second dithering mask pattern Rdm2) may reduce flicker caused by a phenomenon in which an energy spectrum may be concentrated at a specific frequency.

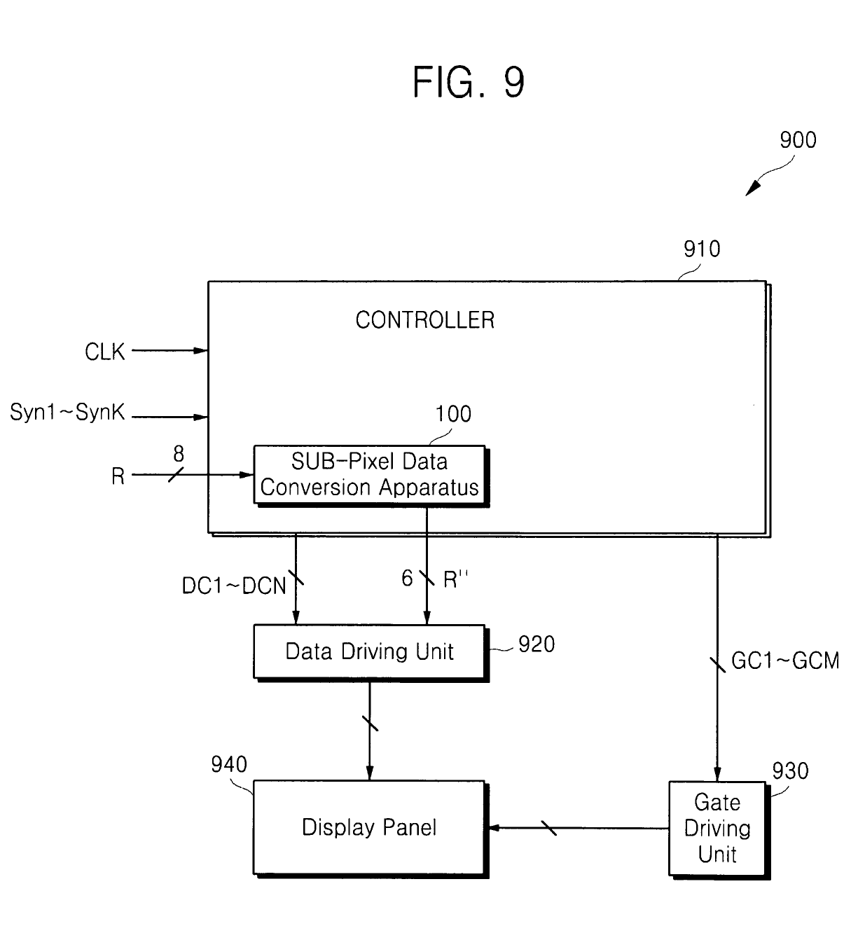

FIG. 9 is a block diagram of display device 900 according to example embodiments. Referring to FIG. 9, display device 900 (e.g., a Liquid Crystal Display or LCD device) may include controller 910, data driving unit 920, gate driving unit 930, and/or display panel 940.

Controller 910 may include sub-pixel data conversion apparatus 100 illustrated in FIG. 1. Controller 910 may generate a plurality of data control signals DC1 to DCN (where N is a natural number greater than 1) for driving data driving unit 920 and/or a plurality of gate control signals GC1 to GCM (where M is a natural number greater than 1) for driving gate driving unit 930 in response to a clock signal CLK. Controller 910 also may receive a plurality of driving signals Syn1 to SynK (where K is a natural number greater than 1) for data processing.

Data driving unit 920 may be connected to data lines (not shown) of display panel 940. Data driving unit 920 may supply a gray voltage (that may correspond to third sub-pixel data R″) that may be converted by sub-pixel data conversion apparatus 100 included in controller 910 to a corresponding data line among the plurality of the data lines in response to the plurality of data control signals DC1 to DCN.

Gate driving unit 930 may be connected to gate lines (not shown) of display panel 940. Gate driving unit 930 may drive the gate lines in response to the plurality of gate control signals GC1 to GCM.

Display panel 940 may include a plurality of pixels (not shown). The plurality of pixels may be connected to a corresponding data line among the plurality of data lines and/or a corresponding gate line among the plurality of the gate lines, and/or may be configured in a matrix type on display panel 940.

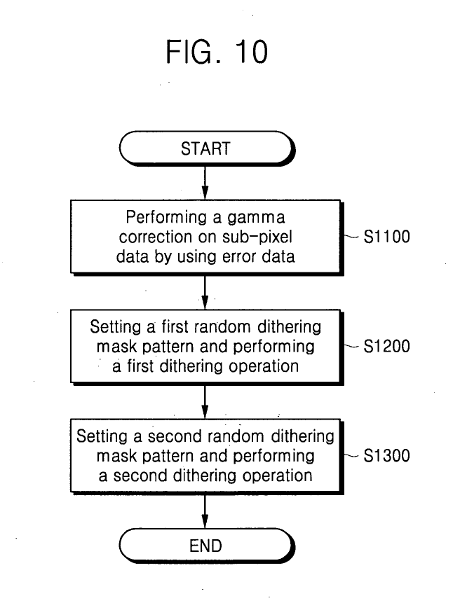

FIG. 10 is a flowchart of a sub-pixel data conversion method according to example embodiments. Referring to FIG. 10, a method for converting the sub-pixel data may include gamma correction step S1100, first dithering step S1200, and/or second dithering step S1300.

Referring to FIGS. 1 and 10, at gamma correction step S1100, error data DR (that may be a difference between sub-pixel data R and gamma-corrected sub-pixel data ER) may be set up to error data storage unit 112 for a gamma correction on sub-pixel data R. Error data DR may have a number of bits less than or equal to the number of bits in sub-pixel data R. Error data DR may be similar to that explained with regard to FIG. 2.

Gamma correction block 110 may extract error data DR corresponding to first sub-pixel data R, may add extracted error data DR and first sub-pixel data R, and/or may generate gamma-corrected sub-pixel data ER (whose number of bits may be extended as compared with first sub-pixel data R based on a result of the addition. Gamma-corrected sub-pixel data ER may be generated as explained with regard to FIG. 2.

Referring to FIGS. 1 and 10, at first dithering step S1200, first dithering module 122 may generate a first dithering mask pattern (that may be random in time and/or in space) for a first macro pixel having a sub-pixel as a reference unit. The method of generating the first dithering mask pattern may be similar to the method explained with regard to FIGS. 3 and 4.

In addition, first dithering module 122 may perform a first dithering operation to convert gamma-corrected sub-pixel data ER to second sub-pixel data R′, that may have fewer bits (e.g., 2 fewer bits) than gamma-corrected sub-pixel data ER, based on the generated first dithering mask pattern. The method of performing the first dithering operation may be similar to that explained with regard to FIG. 5.

At second dithering step S1300, second dithering module 124 may generate a second dithering mask pattern (that may be random in time and/or in space) for a second macro pixel having the first macro pixel as a reference unit. The method of generating the second dithering mask pattern may be similar to that explained with regard to FIGS. 6 and 7.

Additionally, second dithering module 124 may perform a second dithering operation to convert second sub-pixel data R′ to third sub-pixel data R″, that may have fewer bits (e.g., 2 fewer bits) than second pixel data R′, based on the generated second dithering mask pattern. The method of performing the second dithering operation may be similar to that explained with regard to FIG. 8.

An apparatus and/or a method for converting sub-pixel data according to example embodiments may reduce a memory volume storing parameters for gamma correction by using error data.

An apparatus and/or a method for converting sub-pixel data according to example embodiments also may reduce flicker caused by a phenomenon in which an energy spectrum is concentrated on a specific frequency by setting up randomly in time and/or in space a first dithering mask pattern for a 2×2 first macro pixel, that may have a sub-pixel as a reference unit, and/or a second dithering mask pattern for a 2×2 second macro pixel, that may have the first macro pixel as a reference unit.

While example embodiments have been particularly shown and described, it will be understood by those of ordinary skill in the art that various changes in form and details may be made therein without departing from the spirit and scope of the present invention as defined by the following claims.

What is claimed is:

1. A sub-pixel data conversion apparatus, comprising:
a gamma correction block, based on error data which is set in advance and has a number of bits less than or equal to a number of bits of input sub-pixel data, that converts the input sub-pixel data to first sub-pixel data; and
a dithering process block that generates a first dithering mask pattern which is random in time or space for a first macro pixel having a sub-pixel as a first reference unit, and that performs a first dithering operation on the first sub-pixel data to a second sub-pixel data based on the generated first dithering mask pattern.

2. The apparatus of claim 1, wherein the dithering process block generates a second dithering mask pattern, which is random in time or space for a second macro pixel having the first macro pixel as a second reference unit, and performs a second dithering operation on the second sub-pixel data to a third sub-pixel data based on the generated second dithering mask pattern.

3. The apparatus of claim 1, wherein the first dithering mask pattern has an average in time equal to an average in space.

4. The apparatus of claim 2, wherein the second dithering mask pattern has an average in time equal to an average in space.

5. The apparatus of claim 1, wherein the gamma correction block comprises:
an error data storage unit that stores the error data, which is set in advance and represents a difference between a value of the input sub-pixel data and a value of the first sub-pixel data, and that extracts error data corresponding to the input sub-pixel data; and
a first adder that outputs the first sub-pixel data based on a result of adding the input sub-pixel data and error data extracted from the error data storage unit.

6. The apparatus of claim 2, wherein the dithering process block comprises:
a first dithering module that converts the first sub-pixel data to the second sub-pixel data, wherein a number of bits of the second sub-pixel data is less than a number of bits of the first sub-pixel data based on the generated first dithering mask pattern when the first macro pixel is a 2×2 macro pixel; and
a second dithering module that converts the second sub-pixel data to the third sub-pixel data, wherein a number of bits of the third sub-pixel data is less than a number of bits of the second sub-pixel data based on the generated second dithering mask pattern when the second macro pixel is a 2×2 macro pixel.

7. The apparatus of claim 6, wherein the first dithering module comprises:
a first dithering mask pattern generation unit that randomly sets a first macro random number for the first macro pixel included in a frame, which is selected randomly in time among a plurality of first frames, and that sets the first dithering mask pattern based on the set first macro random number; and
a first dithering operation unit that converts the first sub-pixel data to the second sub-pixel data based on the first dithering mask pattern.

8. The apparatus of claim 7, wherein the second dithering module comprises:
a second dithering mask pattern generation unit that randomly sets a second macro random number for the second macro pixel included in a sub-frame, which is selected randomly in time among a plurality of sub-frames including the plurality of first frames, and that sets the second dithering mask pattern based on the set second macro random number; and
a second dithering operation unit that converts the second sub-pixel data to the third sub-pixel data based on the second dithering mask pattern.

9. The apparatus of claim 7, wherein the first dithering operation unit comprises:
a first data separator that separates the first sub-pixel data into a first data set and a second data set;
a first comparator that compares the second data set with the first dithering mask pattern and that outputs a first comparison value; and
a second adder that adds the first comparison value and a value of the first data set, and that outputs the second sub-pixel data.

10. The apparatus of claim 8, wherein the second dithering operation unit comprises:
a second data separator that separates the second sub-pixel data into a third data set and a fourth data set;
a second comparator that compares the fourth data set with the second dithering mask pattern and that outputs a second comparison value; and
a third adder that adds the second comparison value and a value of the third data set, and that outputs the third sub-pixel data.

11. The apparatus of claim 1, wherein the sub-pixel data conversion apparatus is embodied as a part of a controller.

12. The apparatus of claim 1, wherein the sub-pixel data conversion apparatus is embodied as a part of a controller of a display device.

13. A sub-pixel data gamma correction method, comprising:
setting error data for gamma correction on sub-pixel data, the error data having a number of bits less than or equal to a number of bits of the sub-pixel data; and
extracting error data corresponding to input sub-pixel data, adding the extracted error data and the input sub-pixel data, and converting the input sub-pixel data to first sub-pixel data based on a result of the addition;
wherein a number of bits of the first sub-pixel data is greater than a number of bits of the input sub-pixel data.

14. The method of claim 13, wherein the error data comprises:
a sign bit indicating a sign of the error data,
integer bits indicating an integer part of a difference between the input sub-pixel data and the first sub-pixel data, and
floating bits indicating a decimal part of the difference between the input sub-pixel data and the first sub-pixel data.

15. The method of claim 14, wherein converting the input sub-pixel data to first sub-pixel data comprises:
adding the input sub-pixel data and the integer bits based on the sign bit, setting a result of the addition as an integer part of the first sub-pixel data, and setting the floating bits as a decimal part of the first sub-pixel data.

16. The method of claim 13, further comprising:
generating a first dithering mask pattern, which is random in time or space for a first macro pixel having a sub-pixel as a first reference unit; and
performing a first dithering operation on a first sub-pixel data to a second sub-pixel data based on the generated first dithering mask pattern.

17. The method of claim 16, further comprising:
generating a second dithering mask pattern, which is random in time or space for a second macro pixel having the first macro pixel as a second reference unit; and
performing a second dithering operation on the second sub-pixel data to a third sub-pixel data based on the generated second dithering mask pattern.

18. A sub-pixel data dithering method, comprising:
generating a first dithering mask pattern, which is random in time or space for a first macro pixel having a sub-pixel as a first reference unit;
performing a first dithering operation on a first sub-pixel data to a second sub-pixel data based on the generated first dithering mask pattern;
generating a second dithering mask pattern, which is random in time or space for a second macro pixel having the first macro pixel as a second reference unit; and
performing a second dithering operation on the second sub-pixel data to a third sub-pixel data based on the generated second dithering mask pattern.

19. The method of claim 18, wherein generating a first dithering mask pattern comprises:
setting a first macro random number for the first macro pixel included in a frame, which is selected randomly in time among a plurality of first frames;
setting the first dithering mask pattern randomly based on the set first macro random number; and
performing the first dithering operation to convert the first sub-pixel data to the second sub-pixel data based on the first dithering mask pattern.

20. The method of claim 19, wherein generating a second dithering mask pattern comprises:
setting a second macro random number for the second macro pixel included in a sub-frame, which is selected randomly in time among a plurality of sub-frames including the plurality of first frames;
setting the second dithering mask pattern based on the set second macro random number; and
performing the second dithering operation to convert the second sub-pixel data to the third sub-pixel data based on the second dithering mask pattern.
